(19) United States
(12) Patent Application Publication
(10) Pub. No.: US 2010/0211503 A1
(43) Pub. Date: Aug. 19, 2010

(54) Double Verified Transaction Device and Method

(76) Inventor: Zvi Reiss, Brooklyn, NY (US)

Correspondence Address: Law Office of Michael J. Feigin, 103 The Circle, (http://PatentLawNY.com), Passaic, NJ, 07055, US

(21) Appl. No.: 12/372,761

(22) Filed: Feb. 18, 2009

(51) Int. Cl. G06Q 20/00

(52) U.S. Cl. 705/44; 705/35

(57) ABSTRACT

The disclosed technology comprises methods and devices whereby a device associated with a payer or user, such as a handheld wireless device, communicates an authorization to pay a merchant and also communicates to a financial institution, either directly or indirectly, a version of the authorization. A confirmation of the payment after verification of each communication is then received, in embodiments of the disclosed technology. In this manner, a transaction is carried out only after the device authorizes the transaction to both a merchant and a financial institution, the authorizations taking place substantially simultaneously or being delayed until both authorizations can be sent out from the device.

### FIELD OF THE DISCLOSED TECHNOLOGY

The disclosed technology relates generally to transactions and, more specifically, to methods and devices for verifying transactions.

### BACKGROUND OF THE DISCLOSED TECHNOLOGY

When a consumer enters the store of a merchant or makes an electronic payment online, typically, the methods of verification are one way. When a customer hands over a credit or debit card, the card is swiped and perhaps a pin code is entered or a signature is provided, and then the merchant proceeds to verify the transaction. The transmission of data between the consumer and merchant goes only one way—from consumer to merchant. The merchant then verifies the transaction with a bank.

Since the communication is only one way, this allows only up to a certain level of trust and results in a certain level of fraud that the market has learned to tolerate. For example, by obtaining a credit card of another person, one can swipe and sign and cause a transaction to take place. Or, one can print or use a bad check. Famous internet scams function by using fake cashier's checks or wiring money to a bank account, causing the recipient(s) to send out goods or other money, only to find that they were not actually paid and their bank is holding them liable for the funds that weren't actually received. Merchants and other sellers must then attempt to track down the offending party and seek compensation, which is both costly, in terms of time and money, and often fruitless.

The prior art has attempted to solve some of the aforementioned fraud problems, most notably, U.S. Pat. No. 5,708,422 to Blonder et al. After authorizing a transaction, Blonder confirms this by receiving a communication from a consumer consenting to the purchase by a secondary method, such as requiring a call on a telephone or with use of a pager. Blonder requires separate devices and separately initiated communications which may be time-consuming and subject to user confusion.

Thus, the great number and dollar value of fraudulent transactions that continue to take place are costly to merchants and consumers, and banking companies such as credit card companies show that there is an unsolved and long sought after need to reduce fraud. What is further needed is a way to increase security without causing undo stress to a consumer or banking systems which serve to decrease the number of transactions using such methods.

### SUMMARY OF THE DISCLOSED TECHNOLOGY

It is therefore an object of the disclosed technology to provide more secure transactions.

It is a further object of the disclosed technology to provide simple methods and devices for carrying out such secure transactions.

In an embodiment of the disclosed technology, a merchant payment device comprises a communication channel configured to receive authorization of a transaction directly from a device associated with a payor, wherein said device associated with the payor further transmits a version of the authorization to a financial institution. A communication channel may be a near field communication channel.

In embodiments of the disclosed technology, a second communication channel is configured to receive a version of the authorization of a transaction from the financial institution do so through a second channel, and a confirmation of the transaction is exhibited, such as by displaying a confirmation on a screen of a device associated with a payor, an auditory confirmation is heard, a receipt with transaction information is received, or the like. The merchant payment device may store a first received authorization and wait to receive a second authorization before exhibiting the confirmation of the transaction.

Substantially upon the direct authorization being initiated by the payor, the device of the payor may automatically attempt to transmit a version of the authorization to the financial institution. Such a transmission may be delayed, as when waiting for network connectivity to become available or when configured to send only from a specific network location for added security.

A further embodiment of the disclosed technology is a method involving sending a transaction authorization from a handheld wireless device to a merchant payment device where, upon sending the transaction authorization, a version of the authorization is further transmitted from the handheld wireless device to a financial institution. Then, an indication of approval of the transaction is received. A confirmation of the transaction may be exhibited. The sending of the transaction authorization may utilize near field communication.

The approval may be received only after the merchant payment device receives confirmation from the financial institution. The approval may be received by the handheld wireless device from the financial institution and may further be received from the merchant payment device. Upon completion of at least the steps of sending and transmitting, transaction fees associated with said transaction may be lowered. For example, when both the merchant and the payor verify using the methods of the disclosed technology, a financial institution may charge either party a lower transaction fee.

In a method of verifying a transaction in an embodiment of the disclosed technology, data is received from a device associated with a merchant, the data comprising at least a unique identifier of a transaction and a transaction amount. Data is received from a device associated with a payor, the data comprising the same unique identifier of a transaction and a transaction amount. Each unique identifier and transaction amount is verified as being identical, and data representative of verification of the transaction is sent to at least one device. The received data associated with the merchant may further be an identification of the payor, and the received data associated with the payor may be an identification of the merchant. The unique identifier may be a timestamp.

A computer readable storage medium, in an embodiment of the disclosed technology, has instructions for receiving a transaction authorization via a wireless communication network, instructions for verifying that the transaction authorization was initiated by a handheld wireless device associated with a customer of the wireless communication network, instructions for receiving a transaction request from a merchant device, and instructions for verifying that both the customer and the merchant device approve of the transaction. The instructions also include instructions for sending a verification of authorization to said merchant device and may have instructions for verifying a code entered by the user of the wireless device before verifying the transaction.

### BRIEF DESCRIPTION OF THE DRAWINGS

FIG. 1 shows a high level block diagram of devices used to carry out embodiments of the disclosed technology.

FIG. 2 shows a high level block diagram of devices used to carry out embodiments of the disclosed technology using a service intermediary.

FIG. 3 shows the steps taken by a user in carrying out an embodiment of the disclosed technology.

FIG. 4 shows the steps taken by a merchant in carrying out an embodiment of the disclosed technology.

FIG. 5 shows the steps carried out to authenticate a transaction based on the data provided by a merchant and payor in embodiments of the disclosed technology.

FIG. 6 shows a high level block diagram of a device on which embodiments of the disclosed technology may be carried out.

FIG. 7 shows a high-level block diagram of a computer that may be used to carry out the disclosed technology.

### DETAILED DESCRIPTION OF EMBODIMENTS OF THE DISCLOSED TECHNOLOGY

Embodiments of the disclosed technology comprise methods and devices whereby a device associated with a payor or user, such as a handheld wireless device, communicates an authorization to pay a merchant and also communicates to a financial institution, either directly or indirectly, a version of the authorization. A confirmation of the payment after verification of each communication is then received, in embodiments of the disclosed technology. In this manner, a transaction is carried out only after the device authorizes the transaction to both a merchant and a financial institution, the authorizations taking place substantially simultaneously (that is, the second authorization is sent out as soon as practicable after the first authorization) or delayed until both authorizations can be sent out from the device.

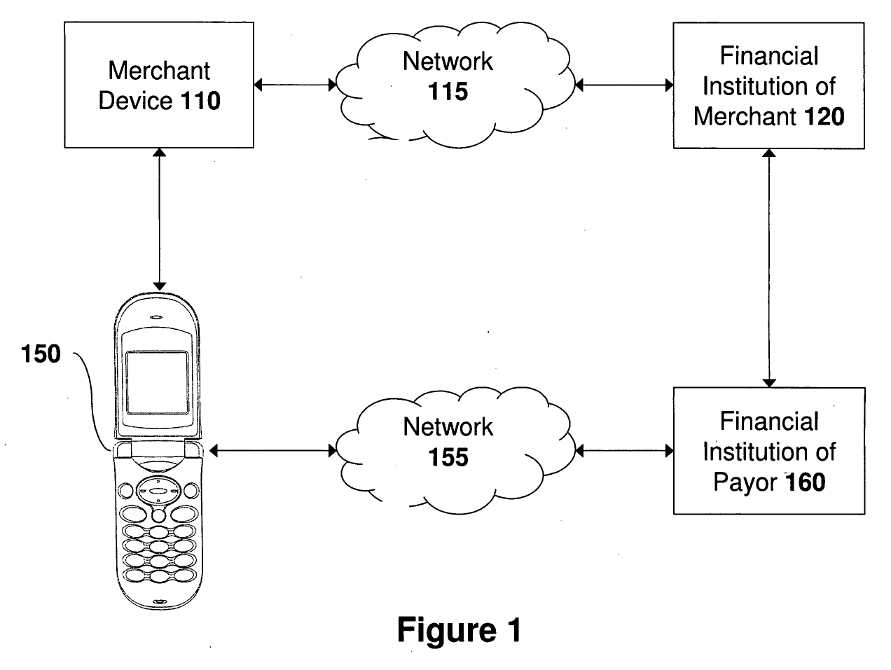

FIG. 1 shows a high level block diagram of devices used to carry out embodiments of the disclosed technology. A handheld wireless device 150, such as a cellular phone, smartcard, personal digital assistant, computer device, or the like. In embodiments of the disclosed technology, the handheld wireless device 150 is any device associated with a user, such as a device which is authenticated for use by a user (e.g., entering a pin code, username, or password to use at least one function of the device) or issued to a specific user, whereby use of the device is the responsibility of the specific user. The handheld wireless device 150 is in communication with a network 155, such as a cellular network, a data network, an 802.11 network, or the like. The communication may be via secure communication link.

Via the network 155, the handheld wireless device 150 is able to communicate uni-directionally or bi-directionally with a financial institution 160, such as a financial institution of the payor. In turn, the financial institution 160 communicates with a financial institution 120, such as a financial institution of, or associated with, a merchant. (The merchant is described below.) The financial institutions 120 and 160 may be a bank, an investment firm, a credit card processing company, a credit card company, a merchant services company, or intermediary servers or computing devices used to process and/or verify transactions.

The financial institution 120 associated with the merchant communicates via a network 115 with a merchant device 110. The merchant device 110 may, for example, be a credit card processing machine, cash register, or other device capable of receiving data from the handheld wireless device 150 (or another device of a user). The data received may, for example, be an authorization of a transaction presented by the merchant device 110 to the user. Network 115 may be a phone network, an internet protocol network, or any other wired or wireless network allowing the merchant, a person or entity selling a product or service, or a merchant device 110, a device acting on behalf of or with the instructions of a merchant, to communicate with the financial institution 120.

In embodiments of the disclosed technology, the merchant device 110 presents an item for sale to a user (e.g., a payor). In one such embodiment, this is by way of near field communication (NFC), whereby only close proximate contact (which may or may not include actual physical contact) between the handheld wireless device 150 and the merchant device 110 is required. Rather, as is known in the art, data are exchanged between the devices when the devices come in close proximity to each other. The user may verify the transaction on the handheld wireless device 150. Based on such a verification, automatically, as soon as practicable (such as when network connectivity via network 155 is obtained or available for use for this purpose), an authorization of the transaction is sent from the handheld wireless device 150 to the financial institution 160 and to the merchant device 110.

The authorizations of the transaction sent to the financial institution 160 and merchant device 110 may be identical or may be independent versions thereof. A transaction authorization may comprise any or all of the following: unique identification of one or both parties, timestamp, transaction amount, unique identification of the transaction, pin code to identify the transaction, pin code to authorization transactions, or the like. When the transaction authorization is verified, such as by the financial institutions 120 and 160, or by the merchant device 110, or a merchant operating such a device (after having received and validated/verified the authorizations received directly from the handheld wireless device 150 and via network 115), the transaction is allowed to go through (i.e., the money is transferred or instructions to transfer the money are sent) and a confirmation of the transaction may be exhibited. The exhibiting of the confirmation of the transaction may be in the form of a printed receipt, an indication on the handheld wireless device 150 or the merchant device 110, an indication on an invoice or bill received by the payor (such as a credit card bill or bank statement), or the like.

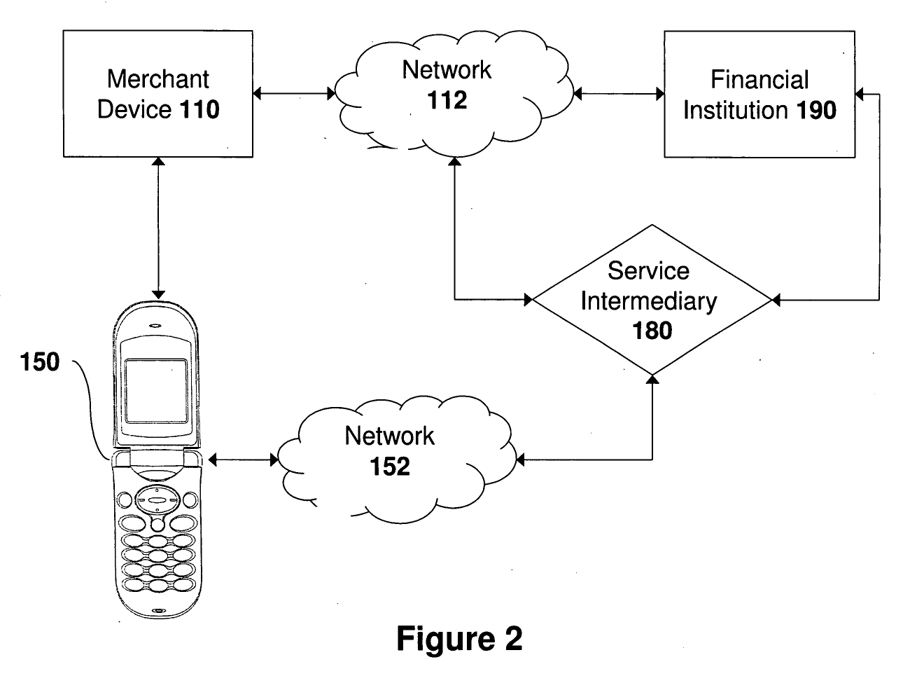

FIG. 2 shows a high level block diagram of devices used to carry out embodiments of the disclosed technology, using a service intermediary. Where the devices used have already been described with reference to FIG. 1, the device numbers have remained constant. The networks, network 112 and network 152, may be any of the types of networks described with reference to network 115 and network 155 and may be the same or different network links. In the embodiment shown in FIG. 2, a service intermediary 180 carries out a function of receiving a version of the transaction authorization from the merchant device 110 via network 112 and a version of the transaction authorization from the handheld wireless device 150 via network 152.

The service intermediary 180, in embodiments of the disclosed technology, is a computer device, server, or host associated with a payment company or providing payment verification services. The service intermediary, in further embodiments of the disclosed technology, determines whether the received transaction authorizations are authentic and sends a confirmation to the merchant device 110 or handheld wireless device 150.

In further embodiments of the disclosed technology, in conjunction with the above described embodiments or as a separate embodiment, the service intermediary further communicates (exchanges data) with a financial institution 190, which may be of the types described with reference to FIG. 1. The financial institution 190 may be associated with the service intermediary 180 and/or with the merchant device 110. Upon authentication of the transaction, that is, upon receiving and validating the authentications received from the merchant device 110 and handheld wireless device 150, the service intermediary 180 sends data to the financial institution 190, allowing the transaction to be completed. The financial institution 190 may then initiate a receipt of funds from the payer/user to the merchant.

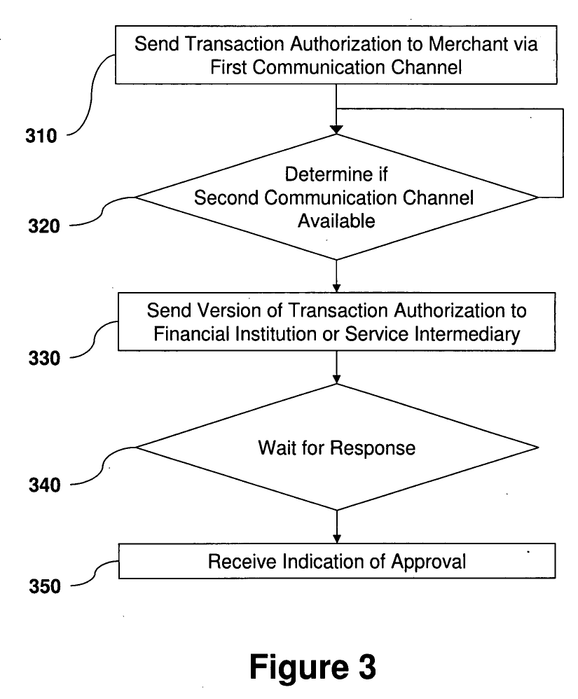

FIG. 3 shows the steps taken by a user in carrying out an embodiment of the disclosed technology. The steps of FIG. 3 may be performed by a user by way of using a handheld wireless device or other device having communication with a device of a merchant and a network, such as handheld wireless device 150. In step 310, a transaction authorization is sent to a merchant via a first communication channel. The transaction authorization has been described with reference to FIG. 1. The first communication channel may be a magnetic strip and reader, near field communication (wireless), the auditory or visual transmission of a code from a payer/user to a merchant, or the like. In step 320, it is determined if a second communication channel is available. The second communication channel may be a cellular network connection, an internet protocol connection, or other network connection. If the second communication channel is not available, then step 320 is repeated until such a channel does become available. In embodiments of the disclosed technology, the second communication channel may be unavailable because of any one of the following conditions: a data connection may be unavailable while the user is using a telephony feature of the wireless device, a signal is not available to the wireless device, and/or the user must attach the device to a home network or other trusted network or trusted location to send an authorization via the second communication channel, rendering the channel unavailable for use for this purpose until connected to the appropriate network.

Once the second communication channel becomes available, in step 330, a version of the transaction authorization (i.e., comprising at least some overlapping data with the transaction authorization sent to the merchant or a device of the merchant) is sent to a financial institution, such as financial institution 160, or a service intermediary, such as service intermediary 180. The user then, in step 340, waits for a response and, in step 350, receives an indication of approval or confirmation, such as by receiving—and exhibition of—confirmation of the transaction. This indication of approval may comprise receiving a product or service being paid for, receiving a visual or auditory signal from the handheld wireless device of the payor, receiving a receipt or invoice listing the transaction as having transpired, or the like.

In this manner, the user, merchant, and financial institutions involved have a higher degree of security than has been previously known in the art, without sacrificing convenience. The device of the user may, or is configured to, directly communicate with a device of the merchant and, further, to automatically or semi-automatically send an authorization to a service intermediary or financial institution, whereby the authorization or a version thereof is actually sent twice. Direct communication means that an intermediary device, network, or service is not used during the communication between two devices. First, the authorization is sent to the merchant, and, second, it is sent via a network that the user subscribes to, such as a cellular or internet network. (The order may be reversed in embodiments of the disclosed technology.) These two authorizations are received at a central location, such as at the device of the merchant, the service intermediary, or one financial institution, or a plurality thereof, where they are cross-referenced and validated before allowing the transaction to be carried out.

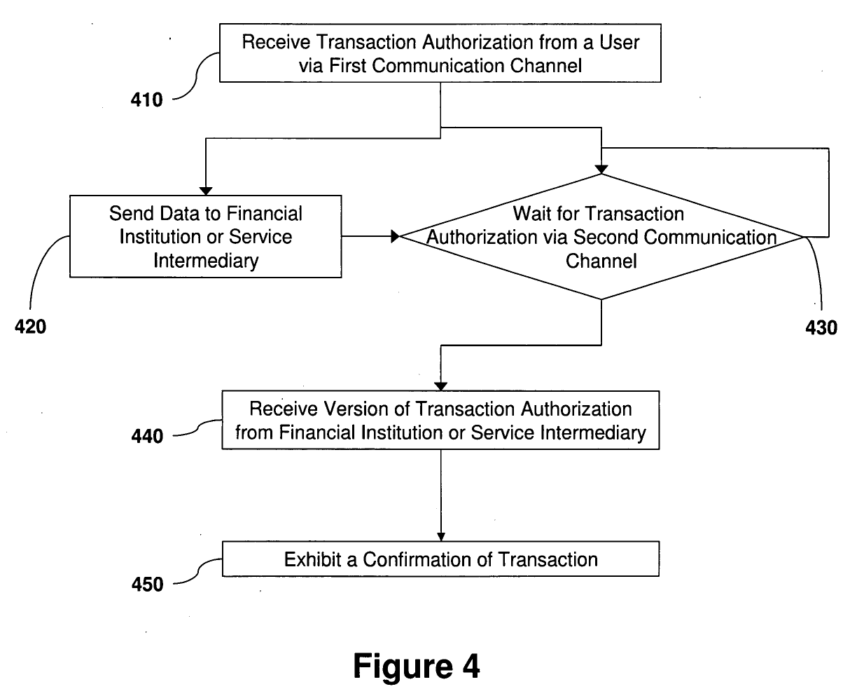

FIG. 4 shows the steps taken by a merchant in carrying out an embodiment of the disclosed technology. It should be understood that the merchant may use a device such as device 110 which has been described with reference to FIG. 1. Such a device may be used to aid or carry out steps of the method shown in FIG. 4 and described herein. In step 410, a transaction authorization from a user is received via a first communication channel, such as a near field communication channel, short range wireless communication, magnetic strip reader, and/or the like. This transaction authorization indicates to a merchant that the user is authorizing a purchase of a good or service and may be received in conjunction with other data exchanged between the merchant and user/payer.

Embodiments of the disclosed technology then proceed to step 420, while other embodiments proceed to step 430 (skipping step 420). In step 420, data is sent from the merchant (which, as noted above, may be either the merchant or a device associated with or under the control of the merchant) to a financial institution, such as financial institution 120 or a service intermediary 180. The data comprises at least a part or all of the transaction authorization for verification and/or carrying out a transfer of funds by the financial institution or service intermediary.

In step 430 (which occurs after either step 410 or 420, depending on the embodiment), the merchant or merchant device waits to receive a transaction authorization via a second communication channel (as described above). If no response is received, step 430 is repeated. If a negative response is received, indicating that the transaction is not acceptable, then the method stops being carried out. However, if an authorization is received via this second communication channel (i.e., a channel other than that by which the first authorization was received, based on a direct data connection between the payer's device and the merchant device), then step 440 is carried out, whereby a version of the transaction authorization or an indication of an authorization to complete the transaction takes place. This may be combined with a request or instructions to transfer funds from the payer to the merchant. Then, in step 450, a confirmation of the transaction is exhibited, which may be a display on a screen of the merchant device, printing of a receipt, providing a good or service to the payer, or the like.

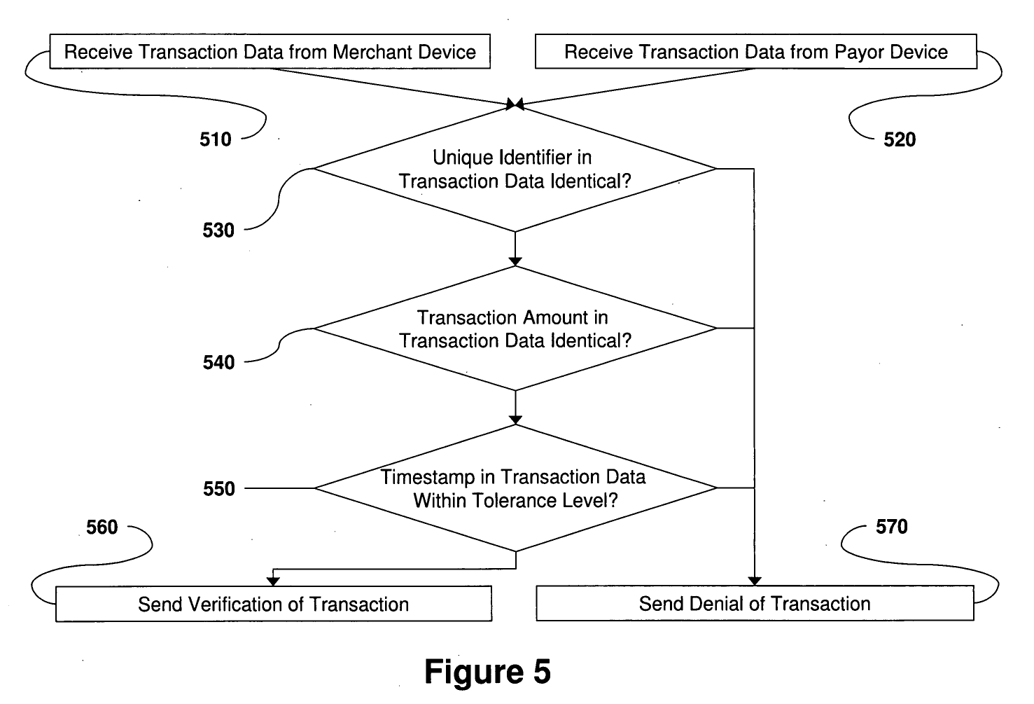

FIG. 5 shows the steps carried out to authenticate a transaction based on the data provided by a merchant and payer in embodiments of the disclosed technology. Such a method may be carried out by a financial institution, service intermediary, merchant, device associated with a merchant, or the like. It should be understood that the method shown in FIG. 5, as a whole, and specifically, steps 530, 540, and 550, are illustrative of one embodiment of the method. Substantially any data received in steps 510 and 520 may be verified to ensure the data is identical or within a threshold of closeness as determined or predetermined by a user carrying out such a method, or instructed a device to carry out such a method. Data which may be sent in steps 510 and 520 may be any of, or a combination of, the following: timestamp of transaction or of sending the data, unique identification number of the payer, unique identification number of the merchant, unique identification number of the transaction, transaction amount, or the like. Further data which may be verified, independent of transaction data received, is a verification of the pathway on which the data is received, e.g., a verification that when the payer sends data over a cellular network to a service intermediary or financial institution, a verification that the data was, in fact, transmitted over a particular cellular or data network, and that the device the data was received from does, in fact, receive network connectivity service from the particular cellular or data network.

In step 510, transaction data is received from the merchant or a device associated with the merchant (such as device 110) and may comprise any or all of the types of data listed in the preceding paragraph. In step 520, transaction data is received from the payer or device associated with the payer (such as handheld wireless device 150). Then, in step 530, based on a transaction identifier sent in step 510 from the merchant and step 520 from the payer, it is determined whether the unique identifier (such as an identification number, alphanumeric characters, or other bits of data) from the merchant and payer are identical. If they are identical (or within a predetermined threshold level), then step 540 is carried out, whereby the transaction amounts are verified in a similar manner. If step 540 yields a positive result, then step 550, in embodiments of the disclosed technology, is carried out whereby a timestamp, such as a timestamp of the transaction as negotiated between the merchant device and payer device or generated independently by each, is verified as being identical or within a threshold such as within one second, one minute, or five minutes. Other data sent may be further verified, and the verifications may take place in any order. In embodiments of the disclosed technology, the timestamp verification is required.

If any of the verification steps are answered negatively, meaning that the data do not match or are not within a predefined tolerance level, then a denial of the transaction is sent in step 570 in some embodiments of the disclosed technology. This may also trigger a fraud investigation or the alerting of a credit card company, phone service provider, or financial institution. The purchasing ability of the device of payer may also be automatically disabled. The failure to properly verify may be as a result of fraud or an error. Similarly, if only one of steps 510 or 520 is completed (i.e., data are not received from both the merchant and the payer), then the transaction will time out and step 570 will be carried out.

If all of the verification steps are answered positively, in an embodiment of the disclosed technology, then step 560 is carried out, whereby verification of the transaction is sent. Such verification may be sent to any one, or a plurality, of the payors, the merchant, a financial institution, multiple financial institutions, or the like. The verification may also trigger the transfer of funds from the payer to the merchant.

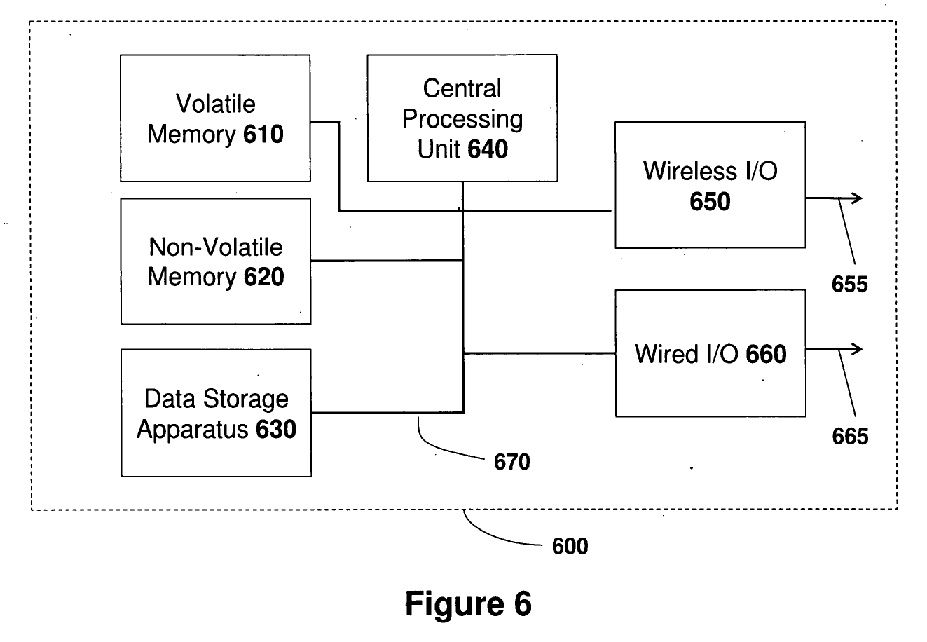

FIG. 6 shows a high level block diagram of a device on which embodiments of the disclosed technology may be carried out. The device may be one associated with, or under the operative control of, a merchant, payer, service intermediary, financial institution, network connectivity provider, or the like. The device may comprise some or all of the high level elements shown in FIG. 6 and may comprise further devices or be part of a larger device.

Data bus 670 transports data between the numbered elements shown in device 600. Central processing unit 640 receives and processes instructions such as code. Volatile memory 610 and non-volatile memory 620 store data for processing by the central processing unit 640 and for permanent storage on the data storage apparatus 630, which may be a magnetic, optical, or other type of storage mechanism known in the art. Two input/output channels, such as a first wired input/output channel 650 and a second wireless input/output channel 660 communicate via communication channels 655 and 665 respectively. Channel 655 may be a near field communication (NFC) channel, wireless internet (e.g., 802.11), cellular channel, or the like. Channel 665 may be a connection such as a telephone connection, network cable, or the like.

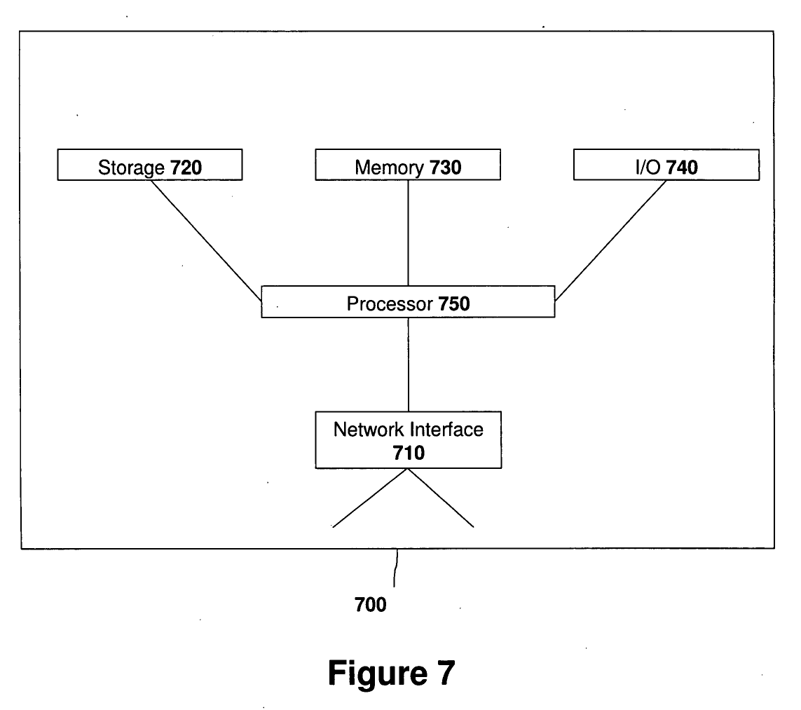

FIG. 7 shows a high-level block diagram of a computer that may be used to carry out the disclosed technology. Computer 700 contains a processor 804 that controls the overall operation of the computer by executing computer program instructions which define such operation. The computer program instructions may be stored in a storage device 808 (e.g., magnetic disk, database) and loaded into memory 712 when execution of the computer program instructions is desired. Thus, the computer operation will be defined by computer program instructions stored in memory 712 and/or storage 708, and the computer will be controlled by processor 704 executing the computer program instructions. Computer 700 also includes one or a plurality of input network interfaces for communicating with other devices via a network (e.g., the internet). Computer 700 also includes one or more output network interfaces 716 for communicating with other devices. Computer 700 also includes input/output 724, representing devices which allow for user interaction with the computer 700 (e.g., display, keyboard, mouse, speakers, buttons, etc.).

One skilled in the art will recognize that an implementation of an actual computer will contain other components as well, and that FIGS. 7 and 8 are high level representations of some of the components of a computer or switch and are for illustrative purposes. It should also be understood by one skilled in the art that the method and devices depicted or described in FIGS. 1 through 6 may be implemented on a device such as is shown in FIG. 7.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

We claim:

1. A merchant payment device comprising:
a communication channel configured to receive authorization of a transaction directly from a device associated with a payer, wherein said device associated with said payer further transmits a version of said authorization to a financial institution;
a second communication channel configured to receive a version of said authorization of a transaction from said financial institution through said second channel; and
means for exhibiting a confirmation of said transaction.

2. The merchant payment device of claim 1, wherein said merchant payment device stores a first received authorization and waits to receive a second said authorization before exhibiting a confirmation of said transaction.

3. The merchant payment device of claim 1, wherein substantially upon said direct authorization being initiated by said payer, said device of said payer automatically attempts to transmit said version of said authorization to said financial institution.

4. The merchant payment device of claim 3, wherein said transmission to said financial institution is delayed.

5. The merchant payment device of claim 4, wherein said delay occurs until network connectivity is available for sending said version of said authorization.

6. The merchant payment device of claim 1, wherein said first communication channel is a near field communication channel and said second communication channel is a wired communication channel.

7. A method, comprising:
sending a transaction authorization from a handheld wireless device to a merchant payment device;
upon sending said transaction authorization, transmitting a version of said authorization from said handheld wireless device to a financial institution; and
receiving an indication of approval of said transaction after said financial institution and said merchant receive said transaction authorization.

8. The method of claim 7, further comprising a step of exhibiting a confirmation of said transaction.

9. The method of claim 7, wherein said sending of said transaction authorization utilizes near field communication.

10. The method of claim 7, wherein said approval is received only after said merchant payment device receives confirmation from said financial institution.

11. The method of claim 10, wherein said approval is received by said handheld wireless device from said financial institution.

12. The method of claim 11, wherein said approval is further received from said merchant payment device.

13. The method of claim 7, wherein said transmission to said financial institution is delayed.

14. The method of claim 7, wherein, upon completion of at least said steps of sending and transmitting, transaction fees associated with said transaction are lowered.

15. A method of verifying a transaction, comprising:
receiving data from a device associated with a merchant, said data comprising at least a unique identifier of a transaction and a transaction amount;
receiving data from a device associated with a payer, said data comprising a unique identifier of a transaction and a transaction amount;
verifying that each received identifier is identical;
verifying that each received transaction amount is identical;
sending data representative of verification of said transaction.

16. The method of claim 15, said received data from a device associated with a merchant comprises an identification of said payer.

17. The method of claim 15, wherein said unique identifier comprises a timestamp.

18. The method of claim 15, wherein said device associated with said merchant and said device associated with said payer communicate via bi-directional near field communication.

19. The method of claim 15, wherein said verification of said transaction is sent to said device associated with said merchant.

20. The method of claim 19, wherein said verification of said transaction is sent to said device associated with said payer.

21. A computer readable storage medium comprising:
instructions for receiving a transaction authorization via a wireless communication network;
instructions for verifying that said transaction authorization was initiated by a handheld wireless device associated with a customer of said wireless communication network;
instructions for receiving a transaction request from a merchant device;
instructions for verifying that both said customer and said merchant device approve of said transaction; and
instructions for sending a verification of authorization to said merchant device.

22. The computer readable storage medium of claim 21, further comprising instructions for sending a verification of authorization to said wireless device.

23. The computer readable storage medium of claim 21, further comprising instructions for verifying a code entered by said user of said wireless device before verifying said transaction.

24. A method of paying, comprising the steps of:
communicating an authorization to send payment to a merchant from a device;
communicating a version of said authorization to a financial institution from said device; and
receiving a confirmation of said payment after verification of each said communication.
